(19) United States
(12) Patent Application Publication
(10) Pub. No.: US 2020/0272820 A1
(43) Pub. Date: Aug. 27, 2020

(54) SYSTEMS AND APPARATUSES FOR CORRELATING TEXTUAL DATA AND IMAGE DATA TO GENERATE ANNOTATED IMAGE DATA

(71) Applicant: Move, Inc., Westlake Village, CA (US)

(72) Inventors: Kui Hsiang Lim, San Jose, CA (US); Ashwini Nandanikar, Newark, CA (US); Samuel John Weller, San Jose, CA (US); Heidy Kurniawan, Sunnyvale, CA (US)

(21) Appl. No.: 16/281,205

(22) Filed: Feb. 21, 2019

(51) Int. Cl. G06K 9/00; G06F 16/9032; G06F 16/9038; G06F 17/27; G06F 17/24

(52) U.S. Cl. CPC G06K 9/00671; G06K 9/00536; G06F 16/90332; G06Q 50/16; G06F 17/2705; G06F 17/2775; G06F 17/241; G06F 16/9038

(57) ABSTRACT

A service provider may receive image data pertaining to real property listings from a multiple listing service (MLS). Textual data relating to real property may also be obtained from various sources, such as the MLS, public records, etc. The image data may be classified to determine classifications such as exterior/interior photos, photos of a kitchen, and/or the like. Textual data may then be processed to identify pertinent information, and correlate the pertinent information to the image data to generate annotated image data. The annotated image data may be presented on a user device so that the user views pertinent textual information while viewing the image data.

### TECHNOLOGICAL FIELD

The present disclosure relates to real property data, and more specifically to correlating structured and/or unstructured textual data with image data to generate annotated image data.

### BACKGROUND

A large portion of the human population are visual learners. Research has shown that these visual learners focus on information that is presented through imagery rather than text. The brain can process information presented in a concise, visually pleasing format more efficiently than text-only formats. In usability studies relating to human-computer interaction, and particularly user interfaces provided via the Internet, users spend more time browsing photos and other imagery-focused visual content in comparison to time spent reading textual content.

Real estate sales is one area where the focus on visual content over text is prevalent. Consumers of real estate listings and other real property (e.g., real estate) data are often drawn directly to photos of real property, and in some instance completely skip or bypass review of the textual descriptions or textual data relating to the property. In some instances, these users contact real estate agents and/or the like, seeking additional information, when the information is actually readily available in the listing but in a textual format.

Many multiple listing services (MLS) syndicate their listings through third party services that provide the listings to providers that present the listings to the public via the web. The providers also collect real property data from the listings themselves, and from an increasing number of data sources such as public records, real property data collection services, real property analytical services, and/or the like. The real property data can come from disparate sources and can be provided in various formats.

### BRIEF SUMMARY

A method, apparatus, computer program product and system are therefore provided for correlating pertinent textual data with image data relating to real property, and generating annotated image data.

In particular, a method is provided herein that includes receiving image data associated with a real property, and classifying, with at least a processor, the image data associated with the real property to determine a classification of the image data. The method may further include receiving textual data associated with the real property, and extracting from the textual data, pertinent information associated with the real property. The textual data may include structured textual data and/or unstructured textual data, and the method may further include processing unstructured textual data to extract the pertinent information from the unstructured textual data. The unstructured textual data may be a natural language description of the real property.

The method may correlate the pertinent information with the image data based on at least the classification of the image data. The method may further include identifying at least one pertinent object in the image data by performing object recognition on the image data, such that the correlation of the pertinent information is further based on the identified at least one pertinent object in the image.

The method may then generate annotated image data associated with the real property by annotating the image data with the correlated pertinent information, and store the generated annotated image data on a memory device in association with the real property. Accordingly, the method may include causing presentation of the generated annotated image data associated with the real property on a user device.

An apparatus is also provided, the apparatus comprising at least one processor and at least one memory, the at least one memory comprising instructions, that when executed by a processor, cause the apparatus to receive image data associated with a real property. The at least one memory may further comprise instructions, that when executed by the processor, cause the apparatus to classify the image data associated with the real property to determine a classification of the image data. The apparatus may be further configured to receive textual data associated with the real property, and to extract from the textual data, pertinent information associated with the real property. The textual data may include structured textual data and/or unstructured textual data, and the memory may include further instructions to cause the apparatus to process unstructured textual data to extract the pertinent information from the unstructured textual data.

The memory may include additional instructions to cause the apparatus to correlate the pertinent information with the image data based on at least the classification of the image data, and to identify at least one pertinent object in the image data by performing object recognition on the image data, such that the correlation of the pertinent information is further based on the identified at least one pertinent object in the image.

The memory may include additional instructions to cause the apparatus to generate annotated image data associated with the real property by annotating the image data with the correlated pertinent information, and store the generated annotated image data in association with the real property. Accordingly, the apparatus may cause presentation of the generated annotated image data associated with the real property on a user device.

A computer program product is also provided, the computer program product comprising a non-transitory computer readable storage medium, and the non-transitory computer readable storage medium comprising instructions, that when executed by an apparatus, cause the apparatus to receive image data associated with a real property, and classify the image data associated with the real property to determine a classification of the image data. The computer program product may further include instructions to cause the apparatus to receive textual data associated with the real property, and extract from the textual data, pertinent information associated with the real property. The textual data may include structured textual data and/or unstructured textual data, and the computer program product may further include instructions to cause the apparatus to process unstructured textual data to extract the pertinent information from the unstructured textual data.

The computer program product may further include instructions to cause the apparatus to correlate the pertinent information with the image data based on at least the classification of the image data, and to identify at least one pertinent object in the image data by performing object recognition on the image data, such that the correlation of the pertinent information is further based on the identified at least one pertinent object in the image.

The computer program product may then generate annotated image data associated with the real property by annotating the image data with the correlated pertinent information, and store the generated annotated image data in association with the real property. T0he computer program product may include instructions for causing presentation of the generated annotated image data associated with the real property on a user device.

An apparatus is also provided with means for receiving textual data associated with the real property, and means for extracting, from the textual data, pertinent information associated with the real property. The apparatus may also include means for correlating the pertinent information with the image data based on at least the classification of the image data, means for generating annotated image data associated with the real property by annotating the image data with the correlated pertinent information, and means for storing the generated annotated image data on a memory device in association with the real property.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a schematic representation of a system that may support certain example embodiments;

FIG. 2 is a block diagram of an electronic device that may be configured to implement certain example embodiments;

FIG. 3 is a flowchart illustrating operations that may be performed according to certain example embodiments;

FIG. 4 is example image data that may be received according to certain example embodiments; and

FIG. 5 is example annotated image data that may be generated according to certain example embodiments.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., one or more volatile or non-volatile memory device), can be differentiated from a “computer-readable transmission medium,” which refers to an electromagnetic signal.

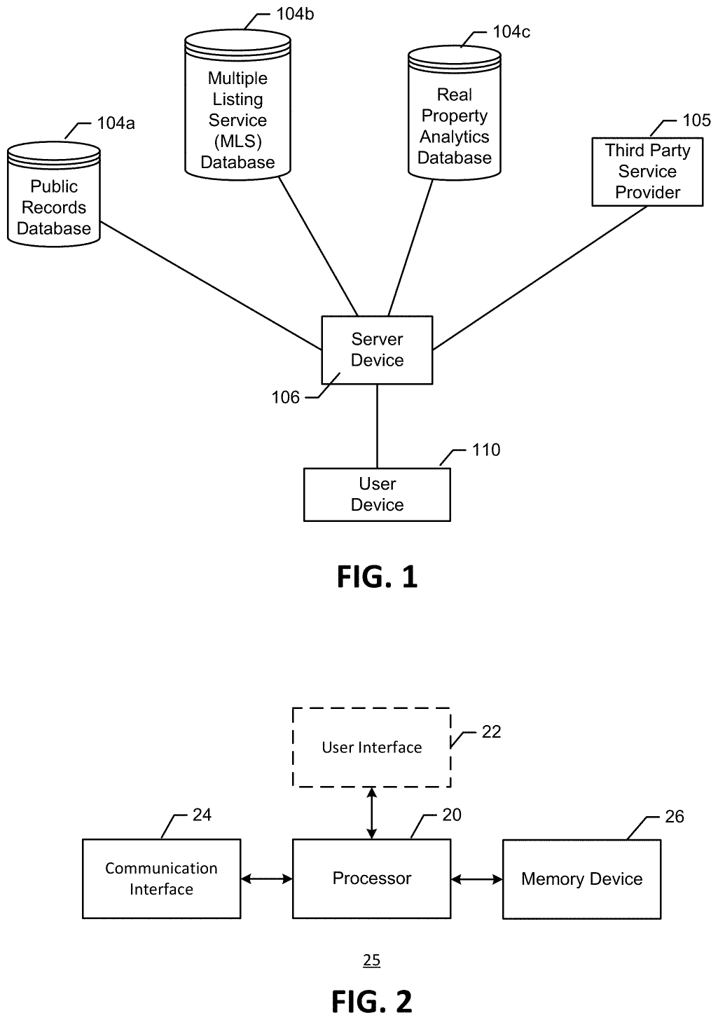

Reference is now made to FIG. 1, which is a schematic representation of a system that may support example embodiments. FIG. 1 illustrates databases 104a, 104b, and 104c. It will be appreciated that databases 104a-104c are provided as example databases, and any number of databases or data sources may be present in the system. Databases 104a-104c may provide any information relating to real property such as a home (e.g., single-family house, duplex, apartment, condominium, etc.), land, commercial property, and/or the like. The databases 104a-c may also provide information indirectly related to real property, such as information relating to neighborhoods, schools, parks, landmarks, transportation, and/or the like.

Public records database 104a, for example, may comprise any data available in the public domain such as but not limited to property records, tax records, neighborhood plats, land surveys, court records, deeds, covenants, sales records, and/or the like. The public records database may be compiled by information brokers, and/or other providers, and provided to the server device 106, described in further detail below.

The Multiple Listing Service (MLS) database 104b may include real property listing data, or listing data, relating to current offerings or past offerings of a real property for sale, and/or transaction records relating to sold properties. The listing data may therefore relate to current properties for sale, pending or under contract properties, closed sales, and/or the like. Listing data may include textual data, image data, audio data and/or files.

The textual data may include unstructured textual data, such as a natural language description of the real property or other feature associated with the listing. The textual data may further include structured textual data, such as property attributes (e.g., data fields) collected by a particular MLS to be included in the listing or transaction record. Structured textual data may include but is not limited to: property price, lot size, the street address of the property, bedroom count, bathroom count, house style, year built, age of the home, name of the builder, name of the neighborhood, room dimensions, and/or number of cars that fit in the garage.

The image data may include photographs of various portions of the real property, a video and/or virtual three-dimensional tour of the property, and/or the like. In this regard the image data may be considered real property image data, but may be referred to herein as “image data,” for simplicity. The image data may relate specifically to the property, or may relate to the neighborhood, nearby schools, community, and/or the like.

It will be appreciated that not every MLS collects the same data, nor are the aforementioned examples intended to be limiting. Different MLSs collect a wide range of data regarding properties and transactions, which in may in turn be provided to the server device 106.

The image data may be in any format such as but not limited to Joint Photographic Expects Group (JPEG or JPG), Tagged Image File Format (TIFF), Graphics Interchange Format (GIF), Portable Networks Graphic (PNG), and/or the like. The image data provided as video or three-dimensional tours may be in formats such as Audio Video Interleave (AVI), Flash Video Format (FLV), Windows Media Video (WMV), Moving Pictures Expert Group 4 (MP4), and/or the like.

The audio data may include audio comments relating to the property. Example audio formats include Waveform Audio File Format (WAV), and/or MP3.

The documents may include floor plans, surveys, site maps, property disclosure forms, inspection reports and/or the like. The files may be provided in any format such as Portable Document Format (PDF), and/or the like.

Real property analytics database 104c may include any other data pertaining to real property, or any data that may be of interest to a user such as a home buyer, seller, investor, and/or the like. The data provided by database 104c may be generated by analytical services that mine and compile data from various sources (such as database 104a and 104b) over time to provide expanded data solutions and intelligence to users or systems integrated therewith. The data may be collected from and/or utilized in underwriting, valuations and appraisals, marketing, risk management, and/or the like. The data may be predictive in nature, showing historical data and trends. The data may relate to particular properties, or may relate to neighboring sold properties in order to provide predictive analytical data. According to some embodiments, the real property analytics database 104c may provide image data such as that related to archived image data, and/or the like. Any of the data provided by real property analytics database 104c may be provided to the server device 106 and utilized according to example embodiments described in more detail below.

The data provided from any of databases 104a-104c and/or other sources may be transmitted to the server device 106 by various methods. For example, a listing syndication service may provide MLS data to the server device 106. In some examples, batch or routine processes may transmit newly added or updated real property data and/or listing data to the server device 106. According to certain embodiments, the data may be provided to the server device 106 continuously, such as in real-time or near real-time once it is received and/or generated at the various sources. As another example, the server device 106 may explicitly request desired data from any of the data sources, such as in response to another process and/or module implemented on the server device 106 and configured to query any of the data sources for such information.

Third party service provider 105 may include any other service provider configured to provide data or information to the server device 106. Whereas the databases 104a-104c may store data, the third party service provider 105 may include an application programming interface (API) such that the server device 106 integrates with the third party service provider 105 to generate visual information and/or the like to users. For example, the third party service provider 105 may be implemented as a map service, which when provided with a property address by the server device 106, generates a map, directions and/or the like for provision to a user. The map service is provided as an example of a third party service provider 105, and it will be appreciated that any service, such as but no limited to geographic information systems (GIS), satellite, drone, and/or other aerial imagery providers, may be utilized by the server device 106 according to example embodiments. It should therefore further be appreciated that any visual data, such as maps, aerial imagery, topographical maps, and/or the like, may be considered image data, and may therefore be processed and annotated as described in further detail below.

The databases 104a-104c and third party service provider 105 are provided merely as examples, and it will be appreciated that many variations may be implemented and utilized in accordance with example embodiments. For example, although not illustrated in FIG. 1, server device 106 may integrate with databases 104a-104c through an API and/or server. Still further, and although not depicted, third party service provider 105 may be implemented at least partially on a database.

In any event, any of databases 104a-104c and/or third party service provider 105, amongst others, may provide any data, such as real property data, to server device 106 that may be utilized according to example embodiments. As used herein, the term “real property data” may refer to any of the data described above that is provided to the server device 106 and pertains to real property.

As used herein, the real property data may include a “real property record,” which may include real property data that is specific to a particular real property. A “real property record” may therefore include a “real property listing,” which may include a real property record and/or real property data that relates to an offering for sale, a past offering for sale, past transaction details of the particular property, and/or the like.

The server device 106, which is described in further detail with regard to FIG. 2 below, is configured to receive data, such as real property data, from the various databases 104a-c and/or third party service provider 105. As such, the server device 106 may be implemented as a real property data provider, but may be referred to herein as the server device 106. According to example embodiments, the server device 106 correlates pertinent textual data with image data, annotates the image data with the textual data, and provides the annotated image data to a user. For example, photographs provided as image data from the MLS database 104b to the server device 106, may be annotated according to example embodiments with textual data received from any of the databases 104a-104c and/or third party service provider 105. The user may access and view the annotated image data using a user device 110, described in further detail below. Although not depicted in FIG. 1, the server device 106 may store the annotated image data on a database and/or other memory.

The user device 110 may be a personal computer or mobile terminal, such as a mobile telephone, PDA, pager, laptop computer, tablet computer, smart phone, or any numerous other hand held or portable communication devices, computation devices, content generation devices, content consumption devices, or combinations thereof. The user device 110 may be used to view real property data (e.g., real property records, real property listings, etc.), compiled and/or provided by the server device 106, for example.

According to some embodiments, a user such as a real estate agent may provide listing data, image data (e.g., listing photos), and/or the like with a user device 110. In this regard, the user device 110 may include an image capturing component such as a camera. The listing data may be provided from the user device 110 via an MLS service and/or MLS database 104b, or in some examples, may be provided from the user device 110 to the server device 106. The listing data provided at the user device 110 may include structured data such as real property attributes, and/or unstructured textual data such as property descriptions.

Although not illustrated, any or all of the components of the system of FIG. 1 may be implemented within a network. Communication between the various components may occur over the network, which may comprise various types of networks. The network may be or may comprise a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network, Wi-Fi, HSPA (High Speed Packet Access), HSPA+ (High Speed Packet Access plus) network, local area network (LAN) or other type of network.

In accordance with some embodiments, the server device 106 and/or user device 110 may be implemented by apparatus 25, such as that shown in FIG. 2 and described in more detail below.

Referring to FIG. 2, apparatus 25 may include or otherwise be in communication with a processor 20, communication interface 24, and memory device 26. As described below and as indicated by the dashed lines in FIG. 2, in some embodiments, the apparatus 25 may also optionally include a user interface 22. Apparatus 25 may be implemented as a server or distributed system, such as a server device 106. In some example, apparatus 25 need not necessarily be embodied by a server, and may be embodied by a wide variety of devices including personal computers and/or work stations.

In some embodiments, the processor 20 (and/or co-processors or any other processing circuitry assisting or otherwise associated with the processor 20) may be in communication with the memory device 26 via a bus for passing information among components of the apparatus 25. The memory device 26 may include, for example, one or more volatile and/or non-volatile memories. In other words, for example, the memory device 26 may be an electronic storage device (e.g., a computer readable storage medium) comprising gates configured to store data (e.g., bits) that may be retrievable by a machine (e.g., a computing device like the processor 20). The memory device 26 may be configured to store information, data, content, applications, instructions, or the like for enabling the apparatus to carry out various functions in accordance with an example embodiment of the present invention. For example, the memory device 26 could be configured to buffer input data for processing by the processor 20. Additionally or alternatively, the memory device 26 could be configured to store instructions for execution by the processor 20. The memory device 26 could be further configured to store the annotated image data generated as described herein according to example embodiments.

The apparatus 25 may, in some embodiments, be embodied in various devices as described above. However, in some embodiments, the apparatus 25 may be embodied as a chip or chip set. In other words, the apparatus 25 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 25 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 26 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal or network entity) configured to employ an embodiment of the present disclosure by further configuration of the processor 20 by instructions for performing the algorithms and/or operations described herein. The processor 20 may include, among other things, a clock, an arithmetic logic unit (ALU) and logic gates configured to support operation of the processor 20.

Meanwhile, the communication interface 24 may be any means such as a device or circuitry embodied in either hardware or a combination of hardware and software that is configured to receive and/or transmit data from/to a network and/or any other device or module in communication with the apparatus 25. In this regard, the communication interface 24 may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface 24 may include a communication modem and/or other hardware/software for supporting communication via cable, digital subscriber line (DSL), universal serial bus (USB) or other mechanisms.

In some embodiments, such as instances in which the apparatus 25 is embodied by a user device, such as user device 110, the apparatus 25 may include a user interface 22 that may, in turn, be in communication with the processor 20 to receive an indication of a user input and/or to cause provision of an audible, visual, mechanical or other output to the user. As such, the user interface 22 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor 20 may be configured to control one or more functions of one or more user interface elements through computer program instructions (e.g., software and/or firmware) stored on a memory accessible to the processor 20 (e.g., memory device 26, and/or the like). In some embodiments, such as instances in which the apparatus 25 is embodied by a user device, such as user device 110, the apparatus 25 may include a camera or other image capturing device, which is configured to capture image data, including photographs and video.

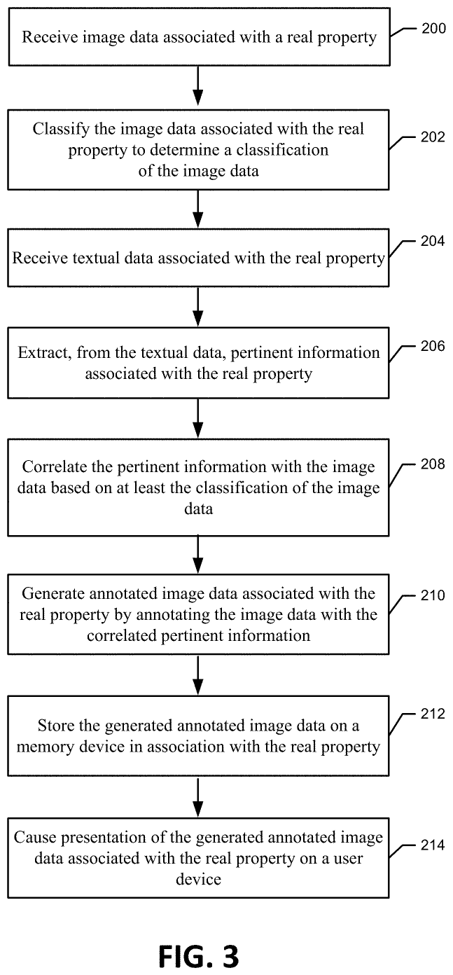

Having now described an apparatus for implementing example embodiments, FIG. 3 is a flowchart of operations that may be performed by server device 106, according to example embodiments.

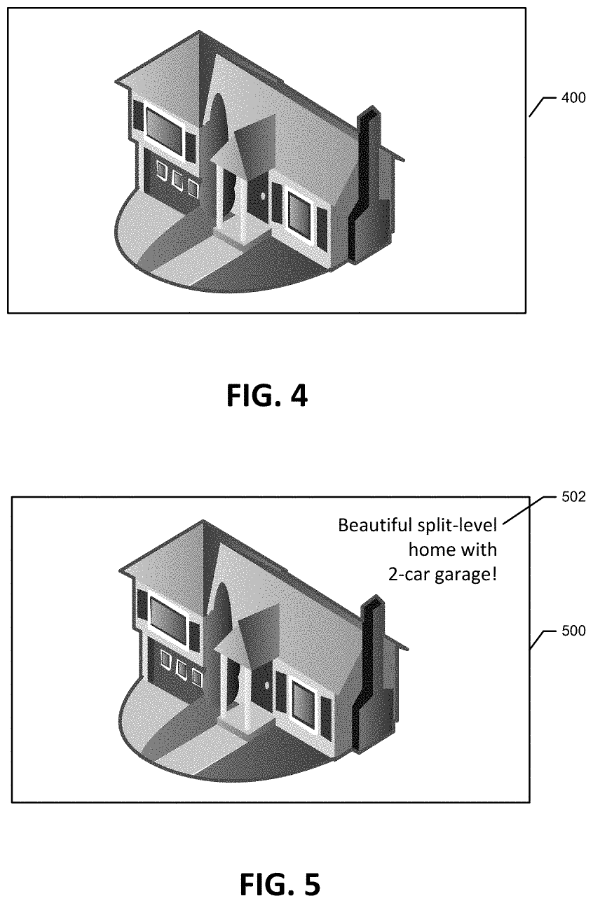

In operation 200, the server device 106 may include means, such as communications interface 24, processor 20, memory 26 and/the like, for receiving image data associated with a real property. The image data may be received from any data source including external and/or internal data sources. For example, the image data may be received from MLS database 104b and/or a user device 110, such as one utilized by a real estate agent to enter a listing, corresponding listing data, and/or transaction details. In certain example embodiments, image data may be received from other sources such as real property analytics database 104c, such as when configured to provide archived image data relating to real properties and/or listings. The image data may be stored locally for access by the server device 106 and/or on a database or other memory device for subsequent processing as described below. FIG. 4 provides example image data 400 that may be received according to certain example embodiments. Image data 400 shows the exterior of a house.

Continuing to operation 202, the server device 106 may include means, such as the communications interface 24, processor 20, memory 26, and/or the like for classifying, with at least a processor, the image data associated with the real property to determine a classification of the image data. The server device 106 may access modules implemented within the server device 106 or external to the server device 106 for classifying the images with respect to categories relevant to real property.

For example, classifications may include exterior and interior image data. The classifications may include other levels of taxonomy. For example, an exterior image may be further classified as a backyard image, front of house, view from the front entrance, and/or the like. Other example classifications may include specific room types, such as kitchen, living room, master bedroom, and/or the like. Other example classification specific to real property may include images from the neighborhood, images of nearby retail shops, images that are computer-generated maps of the area, and/or the like. Accordingly, some image data may have multiple image classifications pertaining to real property.

In operation 204, the server device 106 may include means, such as the communications interface 24, processor 20, memory 26, and/or the like, for receiving textual data associated with the real property. The textual data may include structured and/or unstructured data, and may come from any sources, such as, but not limited to databases 104a-104c, and/or third party service provider 105. The textual data may be stored for access by server device 106.

In operation 206, the server device 106 may include means, such as the communications interface 24, processor 20, memory 26, and/or the like, for extracting, from the textual data, pertinent information associated with the real property. The pertinent information can be determined in a variety of ways, and can be extracted from structured and/or unstructured data.

Structured data, such as specific data fields or real property attributes known to the server device 106, such as those occurring in listing data and/or public records may be scored and/or ranked, such that the fields that are more important to users are scored and/or ranked higher than those that are less important. For instance, heated living area or square footage may be more important to most users in comparison to the driveway type (e.g., concrete or asphalt). As such, structured data, such as data fields or real property attributes, identified as being more pertinent than others, may have a higher chance of being correlated to image data as described in further detail below with regard to operation 208. According to some embodiments, non-pertinent information or information with low relevancy may not be correlated to image data.

In some examples, the structured data providing the pertinent information may be determined based upon prior actions by users. In this regard, example embodiments may utilized previous questions asked by users through an online communication service, such as one provided by server device 106 and/or associated modules. For example, if a large number of users ask how many bedrooms a property has, the bedroom count may be identified as pertinent information.

According to some embodiments, extracting the pertinent information from the textual data may include processing unstructured textual data. Example embodiments may therefore process natural language descriptions of the real property to determine particular words, phrases, sentences, and/or other textual data that may be considered pertinent to the user.

According to certain example embodiments, the pertinent information may be extracted based on the image data received relating to a particular real property. For example, if the listing includes a number of exterior images that is above a specified threshold or percentage of the total images, example embodiments may infer that textual data relating to the exterior is pertinent information. In such an example, the pertinent information could be structured data recognized by the server device 106 as related to exterior characteristics of a property, such a lot dimensions, acreage, special exterior features (e.g., waterfront), and/or the like.

Continuing with the same example, server device 106, having determined that the exterior images are significant for the particular listing, may perform natural language processing methods on unstructured textual data, such as a description of the real property, to identify particular unstructured textual data that is relevant to the exterior image data. Consider the below example real property description:

TABLE 1

Great opportunity to buy a 4 bed/2 bath house
in midtown for under 300k!
This beautiful split-level home features original
hardwood floors, with tileflooring in the kitchen
and baths. 2-car garage. Fresh and neutral interior paint.
Large fenced-in yard.

Given the above real property description, embodiments may be configured to identify key words such as “yard,” as being pertinent to the exterior image data, and therefore designate the context or full sentence, “Large fenced-in yard,” as pertinent information. In some examples, key words may be extracted and pieced together using natural language processing methods and/or preconfigured phrases specifically targeting real property consumers. For example, pertinent information extracted from the above description may include, “beautiful split-level home with 2-car garage!”

It will further be appreciated that according to some embodiments, the unstructured textual data may be in the form of an audio file, such as an audio description of a real property. In any event, the server device 106 may translate the audio description to text, and/or retrieve or receive a text translation of the audio description.

The process by which server device 106 extracts the pertinent information may be modified and/or improved upon over time by a variety of methods. For instance, techniques in artificial intelligence, machine learning, and/or deep learning may be applied to example embodiments to improve the predictability of which information may be pertinent to a consumer. In particular, learning which features of real property pique the interest of or are important to consumers of real property, may provide the foundation for the information extraction to be improved.

Notably, the server device 106 may integrate the process of extracting pertinent information from textual data into the practical application of processing real property data. For instance, any of the data received from public records database 104a, MLS database 104b, real property analytics database 104c, and/or third party service provider 105 may be specifically processed with regard to features and characteristics relevant to real property and/or that are important to consumers of real property. As one example, the textual data may be processed, parsed and/or categorized relative to a taxonomy that is specific to real property. For instance, textual data may be recognized as relating to exterior and/or interior property characteristics, and/or certain rooms within a house, as similarly described with respect to image data classification described above.

In some embodiments, the service provider 106 may then utilize the textual data classifications to determine what textual data is more pertinent that others. For example, since many real property consumers indicate that the kitchen is the most important room when evaluating a subject real property, and a basement less important, textual data indicating “stainless steel appliances” may be determined to be more pertinent than “large basement.” Still further, subtleties in textual data, such as the additional term ‘walk-out’ in “large walk-out basement” may cause the server device 106 to identify the unstructured textual data as more pertinent relative to only “large basement,” as a walk-out basement may be more desirable to a home buyer than a basement that is not walk-out, information that may develop and evolve over time with regard to real property preferences. Similarly, example embodiments may apply intelligence and trends that are specific to particular locals. For example, embodiments may infer that a “lanai” or a “screened porch” is a more important feature in Florida, in comparison to other areas.

In any event, the extraction of pertinent information from textual data may be integrated with information and knowledge specifically tied to the interests of home buyers and other consumers of real property data to annotate real property image data as described herein.

Continuing now to operation 208, the server device 106 may include means, such as the communications interface 24, processor 20, memory 26, and/or the like, for correlating the pertinent information with the image data based on at least the classification of the image data. In some examples, such as the example providing above relating to an exterior image data classification, the classification may be sufficient for the server device 106 to correlate the pertinent information with the image data. For instance, having identified the lot dimensions as pertinent information, and identifying an exterior photo in the image data, the service provider 106 may correlate the lot dimensions with the particular image data.

According to some embodiments, correlating the pertinent information with the image data may include identifying at least one pertinent object in the image data by performing object recognition on the image data. In this regard, further processing of the image data may be performed on image data to identify particular objects in the image data. An image may be classified as a kitchen image, and then further processed by example embodiments to determine that the image data includes a range and a sink. The server device 106 may then parse and/or process the unstructured textual description to identify the pertinent information, “Viking range and farmhouse sink,” and correlate it with the image data. Additional examples of correlations may include correlating an exterior photo of a home with “Craftsman style. Built in 1946.” An exterior photo of a yard may be correlated with, “Lot size: 18,5000 sq. ft. 100 ft. by 185 ft.” In this regard, the correlation of pertinent information to image data is integrated into the practical application of advantageously utilizing characteristics specific to real property data and real property image data, such as those characteristics known to be important to users.

Still further, machine learning techniques can be utilized such that the image processing techniques reflect evolving trends in real property. For example, as users show an increasing interest in interior barn doors, shiplap, and/or the like, object recognition process may be modified to recognize such objects.

It will be appreciated that object recognition may be optional in some embodiments, and the server device 106 may correlate pertinent information with the image data based on the classification of the image data. Yet, in some instances, any of the operations depicted in FIG. 3 may be performed iteratively, such that key objects in image data can be identified, and the appropriate associated pertinent information identified accordingly.

Human-computer interaction with regard to consumers of real property data and real property image data may also be considered when determining correlations of pertinent information to image data, according to example embodiments. For example, many browsers of real property records and/or real property listings view the first image provided. If the first image, which may be an exterior image, is not appealing to the user, or does not provide desirable “curb appeal,” the user moves on to another listing without viewing any more details regarding the property. As another example, a user may scroll through thumbnails until an image of the kitchen is reached, then expand the image. In any event, the server device 106 according to example embodiments may correlate information identified as the most pertinent or highly pertinent with an image that is likely to be viewed first, or is given greater significance from a user, in order to pique a user's interest. Accordingly, example embodiments integrate human-computer interaction studies into the specific and practical application of image data specifically representing real property.

To correlate the extracted pertinent information with image data, the server device 106 may store references or associations in memory 26. For example, the pertinent information may be stored in a designated database table, with an associated unique identifier that references the correlated image data. Other methods for correlating information in a memory device 26 may be used according to example embodiments.

In operation 210, the server device 106 may include means, such as the communications interface 24, processor 20, memory 26, and/or the like, for generating annotated image data associated with the real property by annotating the image data with the correlated pertinent information. Server device 106 may therefore access the stored correlations, and annotate, caption, or augment, the image data with the pertinent information that is in a textual format. In some examples, the pertinent information may be placed advantageously within the image data, such as for example, near a relevant object or feature, but so as not to obstruct the relevant object or feature. Image manipulation techniques may be utilized to generate the annotated image data.

FIG. 5 provides example annotated image data 500 that may be generated according to certain example embodiments. The annotated image data 500 is generated using the image data 400. Having received a property description such as that provided in Table 1 above, example embodiments extract the pertinent information, “Beautiful split-level home with 2-car garage!” The pertinent information 502 is then correlated to image data 400. Example embodiments annotate image data 400 with the correlated pertinent information 502, and generate the annotated image data 500.

In operation 212, the server device 106 may include means, such as the communications interface 24, processor 20, and/or the like, for storing the generated annotated image data on a memory device, such as memory 26, in association with the real property. A reference or unique identifier of the real property record and/or real property listing may be stored in association with the generated annotated image data.

Accordingly, in operation 214, the server device 106 may include means, such as the communications interface 24, processor 20, memory 26, user interface 22, and/or the like, for causing presentation of the generated annotated image data associated with the real property on a user device, such as user device 110. In this regard, when a user browses real property records and/or listings and selects to view the associated images, the user sees the annotated image data. According to some embodiments, the server device 106 may replace previously displayed image data provided by the MLS database 104b with the annotated image data. In this regard, a user accustomed to utilizing the same service provided by server device 106 to access real property image data, may see the annotated image data in its place.

Although the image data is commonly considered to include photos associated with a real property record and/or listing, the image data may additionally or alternatively include video data, which may include three-dimensional tours of real property and/or the like. In this regard, any frame, series of frames, plurality of frames, and/or the like within the video data may be annotated in accordance with the example embodiments described herein. The particular frames annotated may be selected based on the image classification and/or object recognition performed on the video data. Still further, the number of frames, or duration for which an annotation is applied to the video data, may be determined according to example embodiments. For example, the pertinent information may be displayed for as long as the associated detected objects are displayed, and/or as long as particular image classification is reflected in the frames before the video changes to reflect a different classification.

Example embodiments provided herein provide numerous technical advantages to the server device 106 and/or the system in which it operates. Without the functionality of the example embodiments described herein, users who browse real property listings may initiate a substantially larger number of electronic communications regarding the real property listing in comparison to users of a service provider that employs the functionality of the server device 106 described herein. In some examples, the service provider must store the electronic communications, transmit the electronic communications to real estate agents, and facilitate the response process by providing a user interface messaging system (e.g., electronic mailbox) for real estate agents to receive and reply to such inquiries from the user. Although the server device 106 implemented according to example embodiments may facilitate such communications, the number of electronic communications initiated, stored, and transmitted may be substantially less due to the improved real estate image data provided to users. Accordingly, the processing resources and/or amount of memory utilized for facilitating the electronic communications may be reduced. As such, example embodiments provide improvements to the technology of real property electronic data provision.

Although the example embodiments provided herein may be applied in any circumstance or application, certain example embodiments are advantageously integrated into the practical application of enhancing electronic real property data. Real property listing providers are particularly known for collecting real estate data from a plethora of sources and providing the data on the web, and the consumers of such data are notoriously known for focusing on the real property image data while ignoring or only quickly glossing over the textual information associated with a real property or real property listing. Some real estate data providers even allow the user to expand the view of the image data to cover the textual data such that the textual information is out of site, further decreasing the likelihood that the user will view the textual information. However, example embodiments intelligently extract the pertinent information from the textual data, and correlate it with the relevant image data to provide the enhanced annotated image data as described herein. In this regard, the pertinent textual information may be brought into view by the user. Existing real property data providers that enable their users to expand image data to cover the textual data may integrate with the functionality provided by example embodiments, to provide the annotated image data in its place, thereby bringing the pertinent textual information to a more prominent position and increase the likelihood it is viewed by the user.

Moreover, example embodiments described herein may be particularly useful when integrated into the practical application of providing real property data that is received from various sources (e.g., public record database 104a, MLS database 104b, real property analytics database 104c, and third party service provider 105 and/or the like), that provide real property data to server device 106 in a variety of formats. Example embodiments may appropriately apply image processing techniques and extraction of pertinent information, in a way that is non-routine and unconventional, based on information that is important to consumers of real property data and/or real property listings.

Still further, leveraging information regarding user interactions with the real property data and/or listings provided by server device 106, and/or questions frequently asked by real property consumers via electronic communication facilitated by the server device 106 and transmitted to real estate agents, further integrates related processes into the practical application of enhancing real property data. Example embodiments may improve, such as with machine learning and deep learning methodologies, the relevancy of the pertinent information extracted from the textual data and/or the significance of objects recognized in the image data.

As set forth above, the above examples and embodiments described herein provide numerous ways to integrate concepts relating to image processing, information extraction, image annotation and/or the like into the practical application of enhancing real property image data.

It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving image data associated with a real property;
classifying, with at least a processor, the image data associated with the real property to determine a classification of the image data;
receiving textual data associated with the real property;
extracting, from the textual data, pertinent information associated with the real property;
correlating the pertinent information with the image data based on at least the classification of the image data;
generating annotated image data associated with the real property by annotating the image data with the correlated pertinent information; and
storing the generated annotated image data on a memory device in association with the real property.

2. The method of claim 1, further comprising:
identifying at least one pertinent object in the image data by performing object recognition on the image data, wherein the correlation of the pertinent information is further based on the identified at least one pertinent object in the image.

3. The method of claim 1, further comprising:
causing presentation of the generated annotated image data associated with the real property on a user device.

4. The method of claim 1, wherein the textual data comprises unstructured textual data, and the method further comprises:
processing the unstructured textual data to extract the pertinent information from the unstructured textual data.

5. The method of claim 4, wherein the unstructured textual data is a natural language description of the real property.

6. The method of claim 1, wherein the textual data comprises structured textual data.

7. An apparatus comprising at least one processor and at least one memory, the at least one memory comprising instructions, that when executed by a processor, cause the apparatus to:
receive image data associated with a real property;
classify the image data associated with the real property to determine a classification of the image data;
receive textual data associated with the real property;
extract, from the textual data, pertinent information associated with the real property;
correlate the pertinent information with the image data based on at least the classification of the image data;
generate annotated image data associated with the real property by annotating the image data with the correlated pertinent information; and
store the generated annotated image data in association with the real property.

8. The apparatus of claim 7, wherein the at least one memory further comprises instructions, that when executed by the processor, further cause the apparatus to:
identify at least one pertinent object in the image data by performing object recognition on the image data, wherein the correlation of the pertinent information is further based on the identified at least one pertinent object in the image.

9. The apparatus of claim 7, wherein the at least one memory further comprises instructions, that when executed by a processor, further configure the apparatus to:
cause presentation of the generated annotated image data associated with the real property on a user device.

10. The apparatus of claim 7, wherein the textual data comprises unstructured textual data, and the at least one memory further comprises instructions, that when executed by the processor, further cause the apparatus to:
process the unstructured textual data to extract the pertinent information from the unstructured textual data.

11. The apparatus of claim 10, wherein the unstructured textual data is a natural language description of the real property.

12. The apparatus of claim 7, wherein the textual data comprises structured textual data.

13. A computer program product comprising a non-transitory computer readable storage medium, the non-transitory computer readable storage medium comprising instructions, that when executed by an apparatus, cause the apparatus to:
receive image data associated with a real property;
classify the image data associated with the real property to determine a classification of the image data;
receive textual data associated with the real property;
extract, from the textual data, pertinent information associated with the real property;
correlate the pertinent information with the image data based on at least the classification of the image data;
generate annotated image data associated with the real property by annotating the image data with the correlated pertinent information; and
store the generated annotated image data in association with the real property.

14. The computer program product of claim 13, wherein the non-transitory computer readable storage medium further comprise instructions, that when executed by the apparatus, cause the apparatus to:
identify at least one pertinent object in the image data by performing object recognition on the image data, wherein the correlation of the pertinent information is further based on the identified at least one pertinent object in the image.

15. The computer program product of claim 13, wherein the non-transitory computer readable storage medium further comprise instructions, that when executed by the apparatus, cause the apparatus to:
cause presentation of the generated annotated image data associated with the real property on a user device.

16. The computer program product of claim 13, wherein the textual data comprises unstructured textual data, and the non-transitory computer readable storage medium further comprise instructions, that when executed by the apparatus, cause the apparatus to:
process the unstructured textual data to extract the pertinent information from the unstructured textual data.

17. The computer program product of claim 16, wherein the unstructured textual data is a natural language description of the real property.

18. The computer program product of claim 13, wherein the textual data comprises structured textual data.
